(19) United States
(12) Patent Application Publication
(10) Pub. No.: US 2026/0281482 A1
(43) Pub. Date: Sep. 17, 2026

(54) LIVE STREAM DATA PROCESSING METHOD AND DEVICE, AND STORAGE MEDIUM

(71) Applicant: Beijing Zitiao Network Technology Co., Ltd., Haidian District, Beijing (CN)

(72) Inventors: Zhixin GAO, Beijing (CN); Rusong HUAN, Beijing (CN)

(21) Appl. No.: 19/469,562

(22) PCT Filed: Mar. 19, 2024
(86) PCT No.: PCT/CN2024/082483

§ 371 Date: Sep. 26, 2025

(30) Foreign Application Priority Data
Mar. 27, 2023 (CN) 202310317744.5

(51) Int. Cl. H04N 21/2662; H04N 21/2187; H04N 21/442

(52) U.S. Cl. CPC H04N 21/2662; H04N 21/2187; H04N 21/44245

(57) ABSTRACT

The present disclosure provides a live streaming data processing method and device, and a storage medium. The method comprises: in the process of recording live streaming data by a live streaming device, detecting a current performance parameter of the live streaming device (S201); determining target image quality enhancement information of the live streaming data according to the current performance parameter, and performing image quality enhancement on the live streaming data according to the target image quality enhancement information (S202); and determining a target stream pushing bitrate according to the target image quality enhancement information, and according to the target stream pushing bitrate, pushing to a server the live streaming data subjected to the image quality enhancement (S203).

The present application is based on and claims priority to Chinese Application No. 202310317744.5, filed on Mar. 27, 2023, the disclosure of which is incorporated herein by reference in its entirety.

### TECHNICAL FIELD

Embodiments of the present disclosure relate to the field of computer technology, and in particular, to a live stream data processing method and device, and a storage medium.

### BACKGROUND

In an overall process of live streaming, data originates from a stream ingestion end, and the condition of data pushed by the stream ingestion end to a stream server end has a great impact on the user experience of a viewer end. However, with the continuous update and upgrade of live streaming devices, live stream data is becoming increasingly bigger, and transmission of the live stream data causes a great increase in the bandwidth cost and the server cost.

### SUMMARY

Embodiments of the present disclosure provide a live stream data processing method and device, and a storage medium, which allow for a reduction in the bandwidth cost and server cost without loss of image quality.

According to a first aspect, an embodiment of the present disclosure provides a live stream data processing method. The method includes:
detecting a current performance parameter of a live streaming device during a process of the live streaming device recording live stream data;
determining target image quality enhancement information for the live stream data based on the current performance parameter, and performing image quality enhancement on the live stream data based on the target image quality enhancement information; and
determining a target stream ingestion bitrate based on the target image quality enhancement information, and pushing, to a server according to the target stream ingestion bitrate, the live stream data subjected to the image quality enhancement.

According to a second aspect, an embodiment of the present disclosure provides a live stream data processing device. The device includes:
a detection unit configured to detect a current performance parameter of a live streaming device during a process of the live streaming device recording live stream data;
an image quality enhancement unit configured to determine target image quality enhancement information for the live stream data based on the current performance parameter, and perform image quality enhancement on the live stream data based on the target image quality enhancement information; and
a bitrate determination unit configured to determine a target stream ingestion bitrate based on the target image quality enhancement information; and
a communication unit configured to push, to a server according to the target stream ingestion bitrate, the live stream data subjected to the image quality enhancement.

According to a third aspect, an embodiment of the present disclosure provides an electronic device including: at least one processor and a memory, where
the memory stores computer-executable instructions; and
the at least one processor executes the computer-executable instructions stored in the memory, so that the at least one processor performs the live stream data processing method according to the above first aspect and various possible designs of the first aspect.

According to a fourth aspect, an embodiment of the present disclosure provides a computer-readable storage medium storing computer-executable instructions that, when executed by a processor, cause the processor to implement the live stream data processing method according to the above first aspect and various possible designs of the first aspect.

According to a fifth aspect, an embodiment of the present disclosure provides a computer program product including computer-executable instructions that, when executed by a processor, cause the processor to implement the live stream data processing method according to the above first aspect and various possible designs of the first aspect.

In the live stream data processing method and device and the storage medium according to the embodiments of the present disclosure, a current performance parameter of a live streaming device is detected during a process of the live streaming device recording live stream data; target image quality enhancement information for the live stream data is determined based on the current performance parameter, and image quality enhancement is performed on the live stream data based on the target image quality enhancement information; and a target stream ingestion bitrate is determined based on the target image quality enhancement information, and the live stream data subjected to the image quality enhancement is pushed to a server according to the target stream ingestion bitrate.

### BRIEF DESCRIPTION OF THE DRAWINGS

In order to more clearly describe the technical solutions in the embodiments of the present disclosure or in the related art, the accompanying drawings for describing the embodiments or the related art will be briefly described below. Apparently, the accompanying drawings in the description below show the embodiments of the present disclosure, and those of ordinary skill in the art may still derive other accompanying drawings from these accompanying drawings without creative efforts.

FIG. 1 is a diagram of an example application scenario of a live stream data processing method according to an embodiment of the present disclosure;

FIG. 2 is a schematic flowchart of a live stream data processing method according to an embodiment of the present disclosure;

FIG. 3 is a schematic flowchart of a live stream data processing method according to another embodiment of the present disclosure;

FIG. 4 is a schematic flowchart of a live stream data processing method according to another embodiment of the present disclosure;

FIG. 5 is a block diagram of a structure of a live stream data processing device according to an embodiment of the present disclosure; and

FIG. 6 is a schematic diagram of a hardware structure of an electronic device according to an embodiment of the present disclosure.

### DETAILED DESCRIPTION

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

In the related art, a link for transmission of live stream data is basically divided into three parts, namely, a stream ingestion end (a streamer end), a stream server end, and a stream pulling end (a viewer end). Video and audio data are obtained at the stream ingestion end through live streaming devices, including a camera and a microphone, and then compressed and packetized into the live stream data to be pushed to the stream server end (a server). The stream server end is responsible for transcoding and delivery. The stream pulling end pulls the live stream data from the stream server end and then decompresses same to restore the video and audio data for playback.

In an overall process of live streaming, data originates from the stream ingestion end, and the quality of data pushed by the stream ingestion end to the stream server end has a great impact on the user experience of the viewer end. However, with the continuous update and upgrade of live streaming devices, the live stream data is becoming increasingly bigger, and transmission of the live stream data causes a great increase in the bandwidth cost and the server cost.

In order to address the above problem, it is considered in the present disclosure that the bandwidth cost and the server cost may be reduced by lowering a stream ingestion bitrate. The stream ingestion bitrate represents the number of bits of audio and video data that are transmitted per second at the stream ingestion end. The stream ingestion bitrate is proportional to a video image quality, which means that reducing the stream ingestion bitrate may lead to the degradation of image quality. In order to avoid loss of image quality, image quality enhancement may first be performed on the live stream data and then the stream ingestion bitrate may be reduced, so that the degradation of image quality caused by reducing the stream ingestion bitrate can be canceled out. Considering that the performance of a live streaming device may be consumed for image quality enhancement, an appropriate degree of image quality enhancement can be performed on the live stream data based on the current performance of the live streaming device, and then the live stream data is pushed to a server after the stream ingestion bitrate is reduced for the live stream data, ensuring that the bandwidth cost and the server cost are reduced without loss of image quality.

Specifically, the present disclosure provides a live stream data processing method. In the method, a current performance parameter of a live streaming device is detected during a process of the live streaming device recording live stream data; target image quality enhancement information for the live stream data is determined based on the current performance parameter, and image quality enhancement is performed on the live stream data based on the target image quality enhancement information; and a target stream ingestion bitrate is determined based on the target image quality enhancement information, and the live stream data subjected to the image quality enhancement is pushed to a server according to the target stream ingestion bitrate.

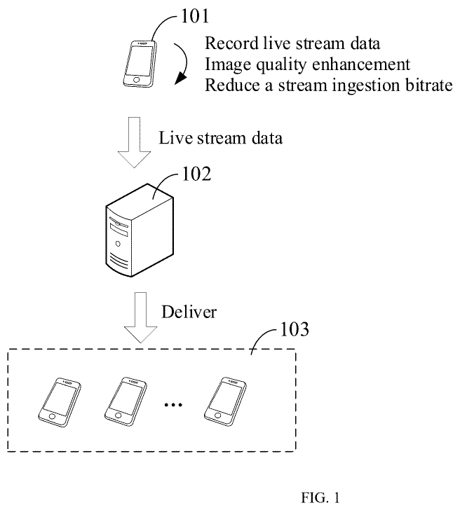

The live stream data processing method according to the present disclosure is applicable to a live streaming system shown in FIG. 1, including a live streaming device 101 at a streamer end (a stream ingestion end), a server 102, and a terminal device 103 of a viewer (a stream pulling end). The live streaming device 101 records live stream data. During the process of the live streaming device 101 recording the live stream data, the above-described live stream data processing method is performed, and the live stream data is finally pushed to the server 102. The server 102 is responsible for transcoding the live stream data and then delivering same to the terminal device 103 of the viewer. The live streaming device 101 includes, but is not limited to, an electronic device, such as a mobile phone, a tablet computer or the like, that can record and ingest the live stream data.

It should be noted that user information and data involved in the present disclosure are information and data for which an authorization is obtained from the user or a full authorization is obtained from each party, and the collection, use, and processing of relevant data need to comply with relevant laws, regulations, and standards of relevant countries and regions, for which corresponding operation entries are provided for the user to choose to authorize or deny.

The live stream data processing method according to the present disclosure is described in detail below with reference to specific embodiments.

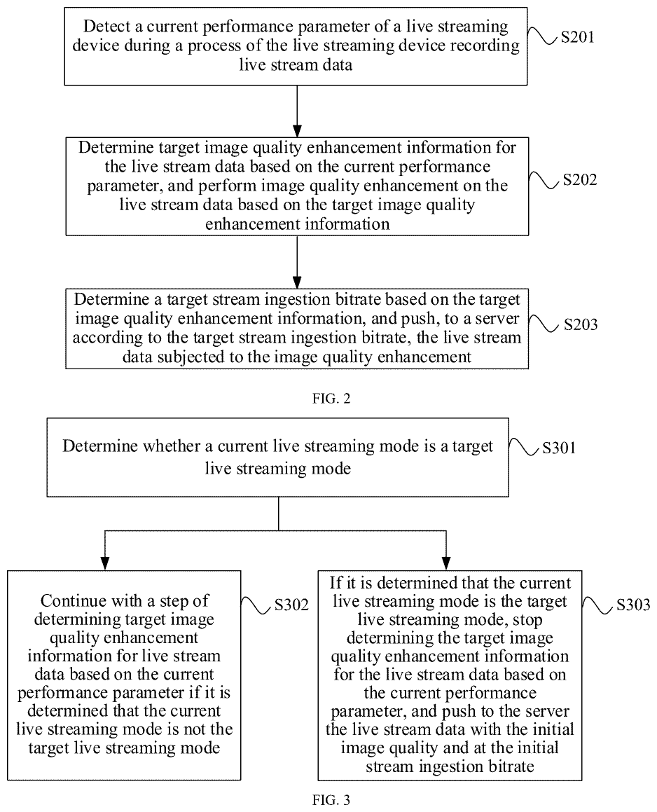

Referring to FIG. 2, FIG. 2 is a schematic flowchart of a live stream data processing method according to an embodiment of the present disclosure. The method of this embodiment may be applied in a live streaming device. The live stream data processing method includes the following steps.

S201: Detect a current performance parameter of a live streaming device during a process of the live streaming device recording live stream data.

Optionally, the live streaming device may start a detection sub-thread to detect the performance parameter.

S202: Determine target image quality enhancement information for the live stream data based on the current performance parameter, and perform image quality enhancement on the live stream data based on the target image quality enhancement information.

In this embodiment, for the image quality enhancement of the live stream data, an image quality enhancement algorithm may be run in the live streaming device, which in turn consumes performance of the live streaming device. A better image quality enhancement effect for the live stream data indicates a need to consume more performance of the live streaming device.

Optionally, the image quality enhancement effect may be classified into levels. For a different image quality enhancement level, an image quality enhancement algorithm that can achieve an image quality enhancement effect corresponding to the level is run, and accordingly, there is also different performance consumption for the live streaming device. For example, the image quality enhancement is classified into three levels: a first image quality enhancement level, a second image quality enhancement level, and a third image quality enhancement level, where the first image quality enhancement level is higher than the second image quality enhancement level, and the second image quality enhancement level is higher than the third image quality enhancement level. The highest one (e.g., the first image quality enhancement level) of the three image quality enhancement levels needs to consume most device performance and also enables output of a highest-quality image. A higher level of image quality enhancement algorithm is suitable for application in a live streaming channel that has a higher-performance live streaming device and satisfies a certain condition. The lowest one (e.g., the third image quality enhancement level) of the three image quality enhancement levels consumes least device performance and enables output of an image with a lower quality than that for a higher image quality enhancement level, but can be applicable to more live streaming devices.

In order to ensure stable performance of the live streaming device, the target image quality enhancement information for the live stream data can be determined based on the current performance parameter of the live streaming device, where the target image quality enhancement information is a target image quality enhancement level. Specifically, a better performance that the current performance parameter of the live streaming device reflects indicates a higher level of image quality enhancement algorithm that the live streaming device is currently allowed to run, and thus a higher target image quality enhancement level.

After the target image quality enhancement level is determined, the image quality enhancement can be performed based on the target image quality enhancement level, so that the image quality of the live stream data achieves the effect corresponding to the target image quality enhancement level. Specifically, the image quality enhancement can be performed on the live stream data by using an image quality enhancement algorithm corresponding to the target image quality enhancement level. A higher target image quality enhancement level indicates a higher image quality enhancement quality that the corresponding image quality enhancement algorithm achieves. Optionally, image quality enhancement algorithms corresponding to different image quality enhancement levels may differ in the granularity of data processing, resulting in different image quality enhancement qualities. For example, an image quality enhancement algorithm corresponding to a low image quality enhancement level may perform image quality enhancement at a granularity of 4×4 pixels, an image quality enhancement algorithm corresponding to a medium image quality enhancement level may perform image quality enhancement at a granularity of 2×2 pixels, and an image quality enhancement algorithm corresponding to a high image quality enhancement level may perform image quality enhancement at a granularity of a single pixel, where the image quality enhancement algorithms may be any algorithm, for example, a neural network model, that can implement image quality enhancement.

S203: Determine a target stream ingestion bitrate based on the target image quality enhancement information, and push, to a server according to the target stream ingestion bitrate, the live stream data subjected to the image quality enhancement.

In this embodiment, in order to reduce the bandwidth cost and server cost, the stream ingestion bitrate can be reduced for the live stream data, where the stream ingestion bitrate represents the number of bits of the live stream data (audio and video data) that are transmitted per second by the stream ingestion end, and a lower stream ingestion bitrate indicates a lower bandwidth cost and server cost. However, the stream ingestion bitrate is proportional to image quality, which means that a lower stream ingestion bitrate indicates a lower image quality. However, since the live stream data has been subjected to image quality enhancement, reducing the stream ingestion bitrate based on the image quality enhancement can ensure that the bandwidth cost and the server cost are reduced without loss of image quality.

In the case where the live stream data has been subjected to different levels of image quality enhancement, the stream ingestion bitrate also needs to be adjusted according to the image quality enhancement levels, in order to ensure no loss of image quality. That is, the target stream ingestion bitrate is determined based on the target image quality enhancement level, and the live stream data is pushed to the server according to the target stream ingestion bitrate. Optionally, a higher image quality enhancement level may indicate a larger stream ingestion bitrate reduction extent, and therefore, a larger extent of reduction in the bandwidth cost and the server cost is ensured without loss of image quality.

In the live stream data processing method of this embodiment, the current performance parameter of the live streaming device is detected during the process of the live streaming device recording the live stream data; the target image quality enhancement level for the live stream data is determined based on the current performance parameter, and the image quality enhancement is performed on the live stream data based on the target image quality enhancement level; and the target stream ingestion bitrate is determined based on the target image quality enhancement level, and the live stream data subjected to the image quality enhancement is pushed to the server according to the target stream ingestion bitrate. In this embodiment, an appropriate degree of image quality enhancement is first performed on the live stream data based on the current performance of the live streaming device, and then the live stream data is pushed to the server after the stream ingestion bitrate is reduced for the live stream data, ensuring that the bandwidth cost and the server cost are reduced without loss of image quality.

On the basis of any one of the above embodiments, the determining target image quality enhancement information for the live stream data based on the current performance parameter may specifically include:
determining the target image quality enhancement level corresponding to the current performance parameter based on a mapping relationship between preset performance parameters and image quality enhancement levels. In the mapping relationship between the performance parameters and the image quality enhancement levels, a better performance that the performance parameter reflects corresponds to a higher image quality enhancement level.

In this embodiment, the mapping relationship between the performance parameters and the image quality enhancement levels may be pre-configured. For example, image quality enhancement may be classified into three levels: a first image quality enhancement level, a second image quality enhancement level, and a third image quality enhancement level, and a range of performance parameters corresponding to each image quality enhancement level may be configured, where a higher image quality enhancement level indicates a better performance required, that is, a better performance that a performance parameter reflects corresponds to a higher image quality enhancement level.

During determination of the target image quality enhancement level, the current performance parameter can be matched with the range of performance parameters corresponding to each image quality enhancement level according to the mapping relationship between preset performance parameters and image quality enhancement levels, to determine the target image quality enhancement level corresponding to the current performance parameter.

Accordingly, the mapping relationship between the performance parameters and the image quality enhancement levels as described in the above embodiment includes preset ranges for each performance parameter corresponding to the image quality enhancement levels.

For example, image quality enhancement is classified into three levels: a first image quality enhancement level, a second image quality enhancement level, and a third image quality enhancement level. The current performance parameter includes four performance parameters: a performance parameter 1, a performance parameter 2, a performance parameter 3, and a performance parameter 4. The preset ranges for each performance parameter corresponding to the image quality enhancement levels are as follows.

The performance parameters 1 corresponding to the first image quality enhancement level, the second image quality enhancement level, and the third image quality enhancement level are respectively less than or equal to a %, greater than a % and less than or equal to b %, greater than b % and less than or equal to c %, and the image quality enhancement function being disabled if c % is exceeded, where the critical values a, b, and c of the performance parameters 1 all range from 0 to 100, and a<b<c.

The performance parameters 2 corresponding to the first image quality enhancement level, the second image quality enhancement level, and the third image quality enhancement level are respectively less than or equal to d %, greater than d % and less than or equal to e %, greater than e % and less than or equal to f %, and the image quality enhancement function being disabled if f % is exceeded, where the critical values d, e, and f of the performance parameters 2 all range from 0 to 100, and d<e<f.

The performance parameters 3 corresponding to the first image quality enhancement level, the second image quality enhancement level, and the third image quality enhancement level are: less than or equal to g, greater than g and less than or equal to h, greater than h and less than or equal to i, and the image quality enhancement function being disabled if i is exceeded, where the critical values g, h, and i of the performance parameter 2 all range from 0 to 1000, and g<h<i.

For the performance parameter 4, there are also four levels: a first level, a second level, a third level, and a fourth level, where the first level corresponds to a better performance than the second level, the second level corresponds to a better performance than the third level, and the third level corresponds to a better performance than the fourth level. The performance parameter 4 corresponding to the first image quality enhancement level is of the first level, the performance parameter 4 corresponding to the second image quality enhancement level is of the second level, the performance parameter 4 corresponding to the third image quality enhancement level is of the third level, and the image quality enhancement function is disabled when the performance parameter 4 is of the fourth level.

On the basis of the above embodiment, the determining the target image quality enhancement level corresponding to the current performance parameter based on a mapping relationship between preset performance parameters and image quality enhancement levels may specifically include:
if at least one performance parameter in the current performance parameter is within a preset range for the performance parameter corresponding to an image quality enhancement level and none of the performance parameters in the current performance parameter exceeds an upper limit of a preset range for each performance parameter corresponding to the image quality enhancement level, determining the image quality enhancement level as the target image quality enhancement level corresponding to the current performance parameter.

In this embodiment, when the performance parameters in the current performance parameter are compared with the preset ranges for all the performance parameters corresponding to the image quality enhancement levels, a cask effect-like method is used, in which provided that any performance parameter falls within a preset range for the performance parameter corresponding to a lower image quality enhancement level and does not exceed an upper limit of the preset range, the lower image quality enhancement level is determined as the target image quality enhancement level.

For example, in the above embodiment, if the performance parameter 1 ≤a %, the performance parameter 2≤d %, the performance parameter 3≤g, and the performance parameter 4 being at the first level are all satisfied, all the performance parameters in the current performance parameter are within preset ranges for all performance parameters corresponding to the first image quality enhancement level, and the first image quality enhancement level is determined as the target image quality enhancement level.

If at least one of the performance parameter 1, the performance parameter 2, the performance parameter 3, and the performance parameter 4 fails to satisfy the preset ranges for all performance parameters corresponding to the first image quality enhancement level, but satisfies the following preset range for each performance parameter corresponding to the second image quality enhancement level: a %<performance parameter 1≤b %, d %<performance parameter 2≤e %, g<performance parameter 3≤h, and the performance parameter 4 being at the second level, that is, in which case at least one performance parameter in the current performance parameter is within the preset range for the performance parameter corresponding to the second image quality enhancement level and none of the performance parameters exceeds an upper limit of the preset range for each performance parameter corresponding to the second image quality enhancement level, the second image quality enhancement level is determined as the target image quality enhancement level.

If at least one of the performance parameter 1, the performance parameter 2, the performance parameter 3, and the performance parameter 4 exceeds the upper limit of the preset range for each performance parameter corresponding to the second image quality enhancement level, but satisfies the following preset range for each performance parameter corresponding to the third image quality enhancement level: b %<performance parameter 1≤c %, e %<performance parameter 2≤f %, h<performance parameter 3≤i, and the performance parameter 4 being of the third level, that is, in which case at least one performance parameter in the current performance parameter is within the preset range for the performance parameter corresponding to the third image quality enhancement level and none of the performance parameters exceeds the upper limit of the preset range for each performance parameter corresponding to the third image quality enhancement level, the third image quality enhancement level is determined as the target image quality enhancement level.

If at least one of the performance parameter 1, the performance parameter 2, the performance parameter 3, and the performance parameter 4 exceeds the upper limit of the preset range for each performance parameter corresponding to the third image quality enhancement level, that is, if at least one performance parameter satisfies performance parameter 1>c %, performance parameter 2>f %, performance parameter 3>i, and the performance parameter 4 being of the fourth level, image quality enhancement is disabled, i.e., of the lowest image quality enhancement level.

On the basis of any one of the above embodiment, considering that the current live streaming mode is a special live streaming mode, for example, a live streaming mode in which a plurality of users co-stream (e.g. a player kill (PK) mode), in which more device performance may be consumed, image quality enhancement needs to be disabled in order to ensure normal operation of the current live streaming mode, so as to avoid the performance problem caused by image quality enhancement. Therefore, before the target image quality enhancement level for the live stream data is determined based on the current performance parameter, there may be operations as shown in FIG. 3.

S301: Determine whether a current live streaming mode is a target live streaming mode.

The target live streaming mode includes, but is not limited to, a live streaming mode in which a plurality of users co-stream.

S302: Continue with the step of determining the target image quality enhancement information for the live stream data based on the current performance parameter if it is determined that the current live streaming mode is not the target live streaming mode.

S303: If it is determined that the current live streaming mode is the target live streaming mode, stop determining the target image quality enhancement information for the live stream data based on the current performance parameter, and push to the server the live stream data with the initial image quality and at the initial stream ingestion bitrate.

In this embodiment, if the current live streaming mode is the target live streaming mode, in order to avoid the performance problem caused by image quality enhancement, determining the target image quality enhancement information for the live stream data based on the current performance parameter is stopped, which means that at this time the image quality is still the initial image quality, and in order to ensure no loss of image quality, the stream ingestion bitrate is no longer reduced, which means that the live stream data is pushed to the server with the initial image quality and at the initial stream ingestion bitrate, to ensure smooth operation of the target live streaming mode.

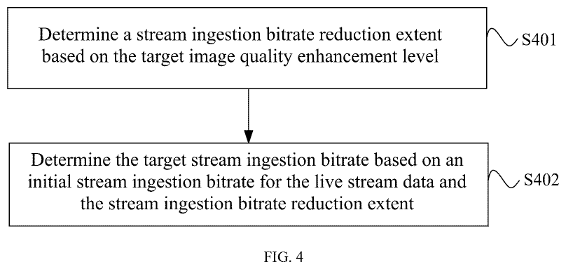

On the basis of any one of the above embodiments, as shown in FIG. 4, the determining a target stream ingestion bitrate based on the target image quality enhancement information as described in step S203 may specifically include the following steps.

S401: Determine a stream ingestion bitrate reduction extent based on the target image quality enhancement level.

S402: Determine the target stream ingestion bitrate based on an initial stream ingestion bitrate for the live stream data and the stream ingestion bitrate reduction extent.

In this embodiment, since the live stream data has been subjected to the image quality enhancement, the stream ingestion bitrate may be reduced, to ensure that the bandwidth cost and the server cost are reduced without loss of image quality. In addition, since a higher image quality enhancement level indicates a larger stream ingestion bitrate reduction extent, the stream ingestion bitrate reduction extent can be determined based on the target image quality enhancement level, and then the target stream ingestion bitrate can be determined by reducing the initial stream ingestion bitrate for the live stream data according to the determined stream ingestion bitrate reduction extent. For example, the initial stream ingestion bitrate is m Mbps, and the target stream ingestion bitrate is n*m Mbps, where 0<n<1.

Specifically, a mapping relationship between preset image quality enhancement levels and stream ingestion bitrate reduction extents may be pre-configured. In the mapping relationship between the image quality enhancement levels and the stream ingestion bitrate reduction extents, a higher image quality enhancement level corresponds to a larger stream ingestion bitrate reduction extent. For example, the stream ingestion bitrate reduction extent is represented as a coefficient, and a high image quality enhancement level, a medium image quality enhancement level, and a low image quality enhancement level correspond to coefficients x, y, and z, respectively, where x, y, and z are floating-point numbers in the range from 0 to 1, and x<y<z. That is, the stream ingestion bitrates corresponding to the high, medium, and low image quality enhancement levels are respectively x, y, and z times the initial stream ingestion bitrate, and the stream ingestion bitrate reduction extents are in the order from large to small.

Therefore, when the target stream ingestion bitrate is determined, the reduction stream ingestion bitrate extent corresponding to the target image quality enhancement level may be determined according to the mapping relationship between the preset image quality enhancement levels and the stream ingestion bitrate reduction extents; and then, the target stream ingestion bitrate may be determined by reducing the initial stream ingestion bitrate and according to the determined stream ingestion bitrate reduction extent.

On the basis of the above embodiment, when the mapping relationship between the preset image quality enhancement levels and the stream ingestion bitrate reduction extents is pre-configured, for any preset image quality enhancement level, a plurality of image qualities corresponding to the preset image quality enhancement level at different stream ingestion bitrate reduction extents may be obtained, i.e., different image qualities are obtained by reducing the stream ingestion bitrate at different reduction extents after the image quality enhancement at the preset image quality enhancement level. The plurality of image qualities are compared with the original image quality (without image quality enhancement or stream ingestion bitrate reduction). If an image quality at a stream ingestion bitrate reduction extent is commensurate with the original image quality, the stream ingestion bitrate reduction extent is determined as the optimal stream ingestion bitrate reduction extent at the preset image quality enhancement level. By repeating the above process for different preset image quality enhancement levels, a stream ingestion bitrate reduction extent corresponding to each preset image quality enhancement level may be obtained, so that a mapping relationship between image quality enhancement levels and stream ingestion bitrate reduction extents may be established. On the basis of the mapping relationship between the image quality enhancement levels and the stream ingestion bitrate reduction extents, the bandwidth cost and the server cost can be minimized.

Certainly, if an image quality at a stream ingestion bitrate reduction extent is better than the original image quality, i.e., the degree of image quality enhancement at the preset image quality enhancement level is larger than the degree of image quality degradation caused by reducing the stream ingestion bitrate, the image quality can also be improved while ensuring reduction in the bandwidth cost and server cost. In other words, the image quality can be improved by adjusting the stream ingestion bitrate reduction extent to achieve a balance between reduction in the bandwidth cost and server cost and improvement in the image quality.

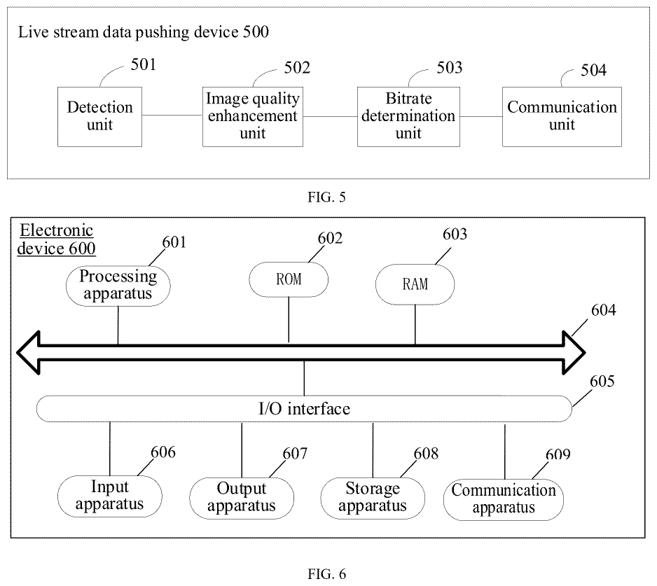

Corresponding to the live stream data processing method in the above embodiment, FIG. 5 is a block diagram of a structure of a live stream data processing device according to an embodiment of the present disclosure. For ease of illustration, only parts related to this embodiment of the present disclosure are shown. With reference to FIG. 5, the live stream data processing device 500 includes: a detection unit 501, an image quality enhancement unit 502, a bitrate determination unit 503, and a communication unit 504.

The detection unit 501 is configured to detect a current performance parameter of a live streaming device during a process of the live streaming device recording live stream data.

The image quality enhancement unit 502 is configured to determine a target image quality enhancement level for the live stream data based on the current performance parameter, and perform image quality enhancement on the live stream data based on the target image quality enhancement level.

The bitrate determination unit 503 is configured to determine a target stream ingestion bitrate based on the target image quality enhancement level.

The communication unit 504 is configured to push, to a server according to the target stream ingestion bitrate, the live stream data subjected to the image quality enhancement.

In one or more embodiments of the present disclosure, the target image quality enhancement information is a target image quality enhancement level.

In one or more embodiments of the present disclosure, upon determining a target stream ingestion bitrate based on the target image quality enhancement information, the bitrate determination unit 503 is configured to:
determine a stream ingestion bitrate reduction extent based on the target image quality enhancement level; and
determine the target stream ingestion bitrate based on an initial stream ingestion bitrate for the live stream data and the stream ingestion bitrate reduction extent.

In one or more embodiments of the present disclosure, upon determining a stream ingestion bitrate reduction extent based on the target image quality enhancement level, the bitrate determination unit 503 is configured to
determine the stream ingestion bitrate reduction extent corresponding to the target image quality enhancement level according to a mapping relationship between preset image quality enhancement levels and stream ingestion bitrate reduction extents,
where in the mapping relationship between the image quality enhancement levels and the stream ingestion bitrate reduction extents, a higher image quality enhancement level corresponds to a larger stream ingestion bitrate reduction extent.

In one or more embodiments of the present disclosure, the bitrate determination unit 503 is further configured to:
obtain a plurality of image qualities corresponding to the preset image quality enhancement level at different stream ingestion bitrate reduction extents; and
compare the plurality of image qualities with an original image quality to determine, as a stream ingestion bitrate reduction extent corresponding to the preset image quality enhancement level, a stream ingestion bitrate reduction extent corresponding to an image quality commensurate with the original image quality, and establish a mapping relationship between image quality enhancement levels and stream ingestion bitrate reduction extents.

In one or more embodiments of the present disclosure, upon determining a target image quality enhancement level for the live stream data based on the current performance parameter, the image quality enhancement unit 502 is configured to determine the target image quality enhancement level corresponding to the current performance parameter based on a mapping relationship between preset performance parameters and image quality enhancement levels.

In one or more embodiments of the present disclosure, the current performance parameter includes at least two performance parameters; and the mapping relationship between performance parameters and image quality enhancement levels includes preset ranges for each performance parameter corresponding to the image quality enhancement levels.

In one or more embodiments of the present disclosure, upon determining the target image quality enhancement level corresponding to the current performance parameter based on a mapping relationship between preset performance parameters and image quality enhancement levels, the image quality enhancement unit 502 is configured to:
if at least one performance parameter in the current performance parameter is within a preset range for the performance parameter corresponding to an image quality enhancement level and none of the performance parameters in the current performance parameter exceeds an upper limit of a preset range for each performance parameter corresponding to the image quality enhancement level, determine the image quality enhancement level as the target image quality enhancement level corresponding to the current performance parameter.

In one or more embodiments of the present disclosure, before determining target image quality enhancement information for the live stream data based on the current performance parameter, the image quality enhancement unit 502 is further configured to
determine whether a current live streaming mode is a target live streaming mode; and
the determining target image quality enhancement information for the live stream data based on the current performance parameter includes:
determining the target image quality enhancement information for the live stream data based on the current performance parameter if it is determined that the current live streaming mode is not the target live streaming mode.

In one or more embodiments of the present disclosure, the image quality enhancement unit 502 is further configured to:
if it is determined that the current live streaming mode is the target live streaming mode, stop determining the target image quality enhancement information for the live stream data based on the current performance parameter, and push to the server the live stream data with the initial image quality and at the initial stream ingestion bitrate.

In one or more embodiments of the present disclosure, the target live streaming mode includes a live streaming mode in which a plurality of users co-stream.

The device provided in this embodiment may be configured to perform the technical solution of the above method embodiment. The implementation principle and technical effects thereof are similar, and are not described herein again in this embodiment.

FIG. 6 is a schematic diagram of a structure of an electronic device 600 suitable for implementing the embodiments of the present disclosure. The electronic device 600 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processing unit or a graphics processing unit) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operations of the electronic device 600. The processing apparatus 601, the ROM 602, and the RAM 603 are connected to one another through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, a gyroscope, etc.; an output apparatus 607 including, for example, a liquid crystal display (LCD), a loudspeaker, a vibrator, etc.; the storage apparatus 608 including, for example, a tape, a hard disk, etc.; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in a reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

In a first aspect, according to one or more embodiments of the present disclosure, a live stream data processing method is provided. The method includes:
detecting a current performance parameter of a live streaming device during a process of the live streaming device recording live stream data;
determining target image quality enhancement information for the live stream data based on the current performance parameter, and performing image quality enhancement on the live stream data based on the target image quality enhancement information; and
determining a target stream ingestion bitrate based on the target image quality enhancement information, and pushing, to a server according to the target stream ingestion bitrate, the live stream data subjected to the image quality enhancement.

According to one or more embodiments of the present disclosure, the target image quality enhancement information is a target image quality enhancement level.

According to one or more embodiments of the present disclosure, the determining a target stream ingestion bitrate based on the target image quality enhancement information includes:
determining a stream ingestion bitrate reduction extent based on the target image quality enhancement level; and
determining the target stream ingestion bitrate based on an initial stream ingestion bitrate for the live stream data and the stream ingestion bitrate reduction extent.

According to one or more embodiments of the present disclosure, the determining a stream ingestion bitrate reduction extent based on the target image quality enhancement level includes:
determining the stream ingestion bitrate reduction extent corresponding to the target image quality enhancement level according to a mapping relationship between preset image quality enhancement levels and stream ingestion bitrate reduction extents,
where in the mapping relationship between the image quality enhancement levels and the stream ingestion bitrate reduction extents, a higher image quality enhancement level corresponds to a larger stream ingestion bitrate reduction extent.

According to one or more embodiments of the present disclosure, the method further includes:
obtaining a plurality of image qualities corresponding to the preset image quality enhancement level at different stream ingestion bitrate reduction extents; and
comparing the plurality of image qualities with an original image quality to determine, as a stream ingestion bitrate reduction extent corresponding to the preset image quality enhancement level, a stream ingestion bitrate reduction extent corresponding to an image quality commensurate with the original image quality, and establishing a mapping relationship between image quality enhancement levels and stream ingestion bitrate reduction extents.

According to one or more embodiments of the present disclosure, the determining a target image quality enhancement level for the live stream data based on the current performance parameter includes:
determining the target image quality enhancement level corresponding to the current performance parameter based on a mapping relationship between preset performance parameters and image quality enhancement levels.

According to one or more embodiments of the present disclosure, the current performance parameter includes at least two performance parameters; and
the mapping relationship between performance parameters and image quality enhancement levels includes preset ranges for each performance parameter corresponding to the image quality enhancement levels.

According to one or more embodiments of the present disclosure, the determining the target image quality enhancement level corresponding to the current performance parameter based on a mapping relationship between preset performance parameters and image quality enhancement levels includes:
if at least one performance parameter in the current performance parameter is within a preset range for the performance parameter corresponding to an image quality enhancement level and none of the performance parameters in the current performance parameter exceeds an upper limit of a preset range for each performance parameter corresponding to the image quality enhancement level, determining the image quality enhancement level as the target image quality enhancement level corresponding to the current performance parameter.

According to one or more embodiments of the present disclosure, before the determining target image quality enhancement information for the live stream data based on the current performance parameter, the method further includes
determining whether a current live streaming mode is a target live streaming mode; and the determining target image quality enhancement information for the live stream data based on the current performance parameter includes:
determining the target image quality enhancement information for the live stream data based on the current performance parameter if it is determined that the current live streaming mode is not the target live streaming mode.

According to one or more embodiments of the present disclosure, the method further includes:
if it is determined that the current live streaming mode is the target live streaming mode, stopping determining the target image quality enhancement information for the live stream data based on the current performance parameter, and pushing to the server the live stream data with the initial image quality and at the initial stream ingestion bitrate.

According to one or more embodiments of the present disclosure, the target live streaming mode includes a live streaming mode in which a plurality of users co-stream.

In a second aspect, according to one or more embodiments of the present disclosure, a live stream data processing device is provided. The device includes:
a detection unit configured to detect a current performance parameter of a live streaming device during a process of the live streaming device recording live stream data;
an image quality enhancement unit configured to determine target image quality enhancement information for the live stream data based on the current performance parameter, and perform image quality enhancement on the live stream data based on the target image quality enhancement information; and
a bitrate determination unit configured to determine a target stream ingestion bitrate based on the target image quality enhancement information; and
a communication unit configured to push, to a server according to the target stream ingestion bitrate, the live stream data subjected to the image quality enhancement.

According to one or more embodiments of the present disclosure, the target image quality enhancement information is a target image quality enhancement level.

According to one or more embodiments of the present disclosure, upon determining a target stream ingestion bitrate based on the target image quality enhancement information, the bitrate determination unit is configured to:
determine a stream ingestion bitrate reduction extent based on the target image quality enhancement level; and
determine the target stream ingestion bitrate based on an initial stream ingestion bitrate for the live stream data and the stream ingestion bitrate reduction extent.

According to one or more embodiments of the present disclosure, upon determining a stream ingestion bitrate reduction extent based on the target image quality enhancement level, the bitrate determination unit is configured to
determine the stream ingestion bitrate reduction extent corresponding to the target image quality enhancement level according to a mapping relationship between preset image quality enhancement levels and stream ingestion bitrate reduction extents,
where in the mapping relationship between the image quality enhancement levels and the stream ingestion bitrate reduction extents, a higher image quality enhancement level corresponds to a larger stream ingestion bitrate reduction extent.

According to one or more embodiments of the present disclosure, the bitrate determination unit is further configured to:
obtain a plurality of image qualities corresponding to the preset image quality enhancement level at different stream ingestion bitrate reduction extents; and
compare the plurality of image qualities with an original image quality to determine, as a stream ingestion bitrate reduction extent corresponding to the preset image quality enhancement level, a stream ingestion bitrate reduction extent corresponding to an image quality commensurate with the original image quality, and establish a mapping relationship between image quality enhancement levels and stream ingestion bitrate reduction extents.

According to one or more embodiments of the present disclosure, upon determining a target image quality enhancement level for the live stream data based on the current performance parameter, the image quality enhancement unit is configured to
determine the target image quality enhancement level corresponding to the current performance parameter based on a mapping relationship between preset performance parameters and image quality enhancement levels.

According to one or more embodiments of the present disclosure, the current performance parameters include at least two performance parameters; and
the mapping relationship between performance parameters and image quality enhancement levels includes preset ranges for each performance parameter corresponding to the image quality enhancement levels.

According to one or more embodiments of the present disclosure, upon determining the target image quality enhancement level corresponding to the current performance parameter based on a mapping relationship between preset performance parameters and image quality enhancement levels, the image quality enhancement unit is configured to:
if at least one performance parameter in the current performance parameter is within a preset range for the performance parameter corresponding to an image quality enhancement level and none of the performance parameters in the current performance parameters exceeds an upper limit of a preset range for each performance parameter corresponding to the image quality enhancement level, determine the image quality enhancement level as the target image quality enhancement level corresponding to the current performance parameters.

According to one or more embodiments of the present disclosure, before determining target image quality enhancement information for the live stream data based on the current performance parameter, the image quality enhancement unit is further configured to determine whether a current live streaming mode is a target live streaming mode; and
the determining target image quality enhancement information for the live stream data based on the current performance parameter includes:
determining the target image quality enhancement information for the live stream data based on the current performance parameter if it is determined that the current live streaming mode is not the target live streaming mode.

According to one or more embodiments of the present disclosure, the image quality enhancement unit is further configured to:
if it is determined that the current live streaming mode is the target live streaming mode, stop determining the target image quality enhancement information for the live stream data based on the current performance parameter, and push to the server the live stream data with the initial image quality and at the initial stream ingestion bitrate.

According to one or more embodiments of the present disclosure, the target live streaming mode includes a live streaming mode in which a plurality of users co-stream.

In a third aspect, according to one or more embodiments of the present disclosure, an electronic device is provided. The electronic device includes: at least one processor and a memory, where
the memory stores computer-executable instructions; and
the at least one processor executes the computer-executable instructions stored in the memory, so that the at least one processor performs the live stream data processing method according to the above first aspect and various possible designs of the first aspect.

In a fourth aspect, according to one or more embodiments of the present disclosure, there is provided a computer-readable storage medium storing computer-executable instructions that, when executed by a processor, cause the processor to implement the live stream data processing method according to the above first aspect and various possible designs of the first aspect.

In a fifth aspect, according to one or more embodiments of the present disclosure, there is provided a computer program product including computer-executable instructions that, when executed by a processor, cause the processor to implement the live stream data processing method according to the above first aspect and various possible designs of the first aspect.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A live stream data processing method, comprising:
detecting a current performance parameter of a live streaming device during a process of the live streaming device recording live stream data;
determining image quality enhancement information for the live stream data based on the current performance parameter, and performing image quality enhancement on the live stream data based on the image quality enhancement information; and
determining a stream ingestion bitrate based on the image quality enhancement information, and pushing, to a server according to the stream ingestion bitrate, the live stream data subjected to the image quality enhancement.

2. The method according to claim 1, wherein the image quality enhancement information comprises an image quality enhancement level.

3. The method according to claim 2, wherein the determining stream ingestion bitrate based on the image quality enhancement information comprises:
determining a stream ingestion bitrate reduction extent based on the target-image quality enhancement level; and
determining the stream ingestion bitrate based on an initial stream ingestion bitrate for the live stream data and the stream ingestion bitrate reduction extent.

4. The method according to claim 3, wherein the determining a stream ingestion bitrate reduction extent based on the image quality enhancement level comprises:
determining the stream ingestion bitrate reduction extent corresponding to the image quality enhancement level according to a mapping relationship between preset image quality enhancement levels and stream ingestion bitrate reduction extents,
wherein in the mapping relationship between the image quality enhancement levels and the stream ingestion bitrate reduction extents, the higher the image quality enhancement level is, the larger the corresponding stream ingestion bitrate reduction extent is.

5. The method according to claim 4, wherein the method further comprises:
obtaining a plurality of image qualities respectively corresponding to the preset image quality enhancement levels at different stream ingestion bitrate reduction extents; and
comparing the plurality of image qualities with an original image quality to determine, as a stream ingestion bitrate reduction extent corresponding to the preset image quality enhancement level, a stream ingestion bitrate reduction extent corresponding to an image quality commensurate with the original image quality, and establishing a mapping relationship between image quality enhancement levels and stream ingestion bitrate reduction extents.

6. The method according to claim 1, wherein the determining an image quality enhancement level for the live stream data based on the current performance parameter comprises:
determining the image quality enhancement level corresponding to the current performance parameter based on a mapping relationship between preset performance parameters and image quality enhancement levels.

7. The method according to claim 6, wherein the current performance parameter comprises at least two performance parameters; and
the mapping relationship between performance parameters and image quality enhancement levels comprises preset ranges for each performance parameter corresponding to the image quality enhancement levels.

8. The method according to claim 7, wherein the determining the image quality enhancement level corresponding to the current performance parameter based on a mapping relationship between preset performance parameters and image quality enhancement levels comprises:
if at least one performance parameter in the current performance parameter is within a preset range for the performance parameter corresponding to an image quality enhancement level and none of the performance parameters in the current performance parameter exceeds an upper limit of a preset range for each performance parameter corresponding to the image quality enhancement level, determining the image quality enhancement level as the image quality enhancement level corresponding to the current performance parameter.

9. The method according to claim 1, wherein before the determining image quality enhancement information for the live stream data based on the current performance parameter, the method further comprises:
determining whether a current live streaming mode is a live streaming mode; and
the determining image quality enhancement information for the live stream data based on the current performance parameter comprises:
determining the image quality enhancement information for the live stream data based on the current performance parameter if it is determined that the current live streaming mode is not the target live streaming mode.

10. The method according to claim 9, wherein the method further comprises:
if it is determined that the current live streaming mode is the live streaming mode, stopping determining the image quality enhancement information for the live stream data based on the current performance parameter, and pushing to the server the live stream data with the initial image quality and at the initial stream ingestion bitrate.

11. The method according to claim 9, wherein the live streaming mode comprises a live streaming mode in which a plurality of users co-stream.

12. (canceled)

13. An electronic device, comprising: at least one processor and a memory, wherein
the memory stores computer-executable instructions; and
the at least one processor executes the computer-executable instructions stored in the memory, so that the at least one processor performs a live stream data processing method, comprising:
detecting a current performance parameter of a live streaming device during a process of the live streaming device recording live stream data;
determining image quality enhancement information for the live stream data based on the current performance parameter, and performing image quality enhancement on the live stream data based on the image quality enhancement information; and
determining a stream ingestion bitrate based on the image quality enhancement information, and pushing, to a server according to the stream ingestion bitrate, the live stream data subjected to the image quality enhancement.

14. A non-transitory computer-readable storage medium storing computer-executable instructions that, when executed by a processor, cause the processor to implement a live stream data processing method, comprising:
detecting a current performance parameter of a live streaming device during a process of the live streaming device recording live stream data;
determining image quality enhancement information for the live stream data based on the current performance parameter, and performing image quality enhancement on the live stream data based on the image quality enhancement information; and
determining a stream ingestion bitrate based on the image quality enhancement information, and pushing, to a server according to the stream ingestion bitrate, the live stream data subjected to the image quality enhancement.

15-16. (canceled)

17. The device according to claim 13, wherein the image quality enhancement information comprises a image quality enhancement level.

18. The device according to claim 17, wherein the determining a stream ingestion bitrate based on the image quality enhancement information comprises:
determining a stream ingestion bitrate reduction extent based on the image quality enhancement level; and
determining the stream ingestion bitrate based on an initial stream ingestion bitrate for the live stream data and the stream ingestion bitrate reduction extent.

19. The device according to claim 18, wherein the determining a stream ingestion bitrate reduction extent based on the image quality enhancement level comprises:
determining the stream ingestion bitrate reduction extent corresponding to the image quality enhancement level according to a mapping relationship between preset image quality enhancement levels and stream ingestion bitrate reduction extents,
wherein in the mapping relationship between the image quality enhancement levels and the stream ingestion bitrate reduction extents, the higher the image quality enhancement level is, the larger the corresponding stream ingestion bitrate reduction extent is.

20. The device according to claim 19, wherein the method further comprises:
obtaining a plurality of image qualities respectively corresponding to the preset image quality enhancement levels at different stream ingestion bitrate reduction extents; and
comparing the plurality of image qualities with an original image quality to determine, as a stream ingestion bitrate reduction extent corresponding to the preset image quality enhancement level, a stream ingestion bitrate reduction extent corresponding to an image quality commensurate with the original image quality, and establishing a mapping relationship between image quality enhancement levels and stream ingestion bitrate reduction extents.

21. The medium according to claim 14, wherein the image quality enhancement information comprises an image quality enhancement level.

22. The medium according to claim 21, wherein the determining a stream ingestion bitrate based on the image quality enhancement information comprises:
determining a stream ingestion bitrate reduction extent based on the image quality enhancement level; and
determining the stream ingestion bitrate based on an initial stream ingestion bitrate for the live stream data and the stream ingestion bitrate reduction extent.

23. The medium according to claim 22, wherein the determining a stream ingestion bitrate reduction extent based on the image quality enhancement level comprises:
determining the stream ingestion bitrate reduction extent corresponding to the image quality enhancement level according to a mapping relationship between preset image quality enhancement levels and stream ingestion bitrate reduction extents,
wherein in the mapping relationship between the image quality enhancement levels and the stream ingestion bitrate reduction extents, the higher the image quality enhancement level is, the larger the corresponding stream ingestion bitrate reduction extent is.
